(19) United States
(12) Patent Application Publication
(10) Pub. No.: US 2017/0003189 A1
(43) Pub. Date: Jan. 5, 2017

(54) INTELLIGENT PRESSURE GAUGE FOR PRESSURIZED FLUID CONTAINER VALVE UNIT

(71) Applicant: L'AIR LIQUIDE, SOCIETE ANONYME POUR L'ETUDE ET L'EXPLOITATION DES PROCEDES GEORGES CLAUDE, Paris (FR)

(72) Inventors: Philippe BERNARD, Goincourt (FR); Philippe DECK, Montreuil (FR); Michele QUATTRONE, Jouy en Josas (FR)

(21) Appl. No.: 15/125,807

(22) PCT Filed: Mar. 10, 2015
(86) PCT No.: PCT/FR2015/050583

§ 371 Date: Sep. 13, 2016

(30) Foreign Application Priority Data
Mar. 14, 2014 (FR) 1452138

(51) Int. Cl. G01L 19/16; G06K 7/10; G06K 9/78; G06K 7/14; G01L 19/08; G06T 7/00

(52) U.S. Cl. CPC G01L 19/16; G01L 19/086; G06T 7/004; G06K 9/78; G06K 7/1417; G06K 7/10722; G06T 2207/30204

(57) ABSTRACT

The invention relates to a pressure gauge comprising a dial comprising a marking and a pressure indicator configured to rotate with respect to the dial, the pressure indicator changing orientation and/or position relative to the markings as it rotates. The marking comprises a two-dimensional code that encodes at least one given information item. The pressure gauge comprises a graphic reference acting as a reference position so that the pressure indicator can be positioned in space. The invention also relates to a valve unit for distributing fluid, particularly gas, comprising such a pressure gauge and an assembly for distributing fluid, particularly gas, comprising a gas container, such as a gas cylinder, to which such a fluid distribution valve unit equipped with such a pressure gauge is fixed. Another aspect of the invention also relates to a method for measuring the pressure displayed by a pressure gauge.

### CROSS REFERENCE TO RELATED APPLICATIONS

This application is a 371 of International PCT Application PCT/FR2015/050583, filed Mar. 10, 2015, which claims priority to French Patent Application No. 1452138, filed Mar. 14, 2014, the entire contents of which are incorporated herein by reference.

### BACKGROUND

The invention relates to a pressure gauge comprising a dial carrying a marking of two-dimensional matrix code type and a pressure indicator, such as a pointer, capable of rotating that is positioned relative to said marking, together with a pressurized fluid container, such as a gas cylinder, equipped with a distribution valve to which a pressure gauge of this kind is fixed, and a method for determining the pressure measured by said pressure gauge.

Industrial and medical gases are commonly packaged in gas containers, typically gas cylinders, equipped with a valve unit, with or without an integral pressure regulator, namely a basic open/closed type valve or a valve with integrated pressure regulator, making it possible to control the flow rate and pressure of the gas delivered.

In order to measure the pressure of the gas in the container and therefore to be able to determine if the container still contains gas or not, it is common to arrange on the valve unit a pressure measuring device, typically a pressure gauge with a pointer capable of rotating.

A pressure measuring device of this kind displays the pressure of the gas on a dial bearing graduations corresponding to pressure values relative to which the rotary pointer is positioned by the effect of the pressure of the gas to indicate a measured pressure value.

In particular, aneroid pressure gauges utilize the elasticity of a metal component the deformation of which by the pressurized fluid, for example the deflection of a diaphragm or the variation of the curvature of a wound tube, such as a Bourdon tube, makes it possible to determine reliably the applied pressure difference and therefore the pressure of the fluid.

The user can then read the pressure of gas in a given cylinder by observing the pressure value corresponding to the graduation designated by the pointer.

They can optionally store it manually in a database associated with the cylinder concerned.

Now, when the user has to manage a stock comprising a plurality of gas containers, typically several tens or hundreds of gas cylinders, they must repeat the operation on all the containers, which very quickly proves laborious and takes all the longer as the number of containers rises.

In other words, managing a stock of gas containers in this way is not the ideal.

The problem that arises is to improve the mechanical pressure measuring devices with a mobile indicator, typically a pressure gauge with a rotary pointer, so as to be able to read the measured pressure value automatically, and to associate this measured pressure value with a given gas container, typically a gas cylinder equipped with a valve unit on which said pressure measuring device is arranged, or even to store it afterwards, advantageously in combination with other useful information, like the type of gas contained in the container concerned, its use by date, the name of the supplier, etc., to improve the overall management of a stock of gas containers, typically gas cylinders.

### SUMMARY

The solution of the invention is a pressure gauge comprising a dial bearing a marking and a pressure indicator capable of rotating with respect to said dial, the pressure indicator as it rotates changing orientation and/or position relative to said marking, characterized in that:

the marking comprises a two-dimensional code that encodes at least one given information item, and

it further comprises at least one reference, such as a graphic element, for example, acting as a reference position so that the pressure indicator can be positioned in space.

The pressure gauge of the invention may comprise one or more of the following technical features, as appropriate:

Said at least one reference is carried by the dial.

The marking comprises said at least one reference.

The two-dimensional code comprises geometric shapes.

The two-dimensional code comprises disks.

The two-dimensional code comprises polygons, in particular squares.

The two-dimensional code comprises geometric shapes of dark color on a background of light color.

The geometric shapes are black squares and the light colored background is a white square.

The two-dimensional code is of QR code type.

The dial is circular.

The geometric shapes are disks of contrasting color compared to the color of the background of the pressure gauge, for example black and white.

The geometric shapes are disks distributed over at least a part of the periphery of the circular dial.

The pressure indicator capable of rotating is a pointer.

The pressure indicator is an elongate pointer of dark color, in particular black.

The rotation axis of the pressure indicator is situated at the center of the dial.

The dial and the pressure indicator are protected by a glass.

It comprises a housing comprising a pressure-sensitive elastic mechanism cooperating with the pressure indicator capable of rotating, for example the pressure-sensitive elastic mechanism is a Bourdon tube or a diaphragm.

The dial comprises graduations enabling direct reading of the pressure by the user without the two-dimensional code impeding reading with the naked eye.

Said at least one reference is or comprises a geometric shape.

Said at least one reference is or comprises a dot, a square or a line; however, another shape may be equally suitable.

Said at least one reference has a shape or a graphic acting as a reference position, which makes it possible to position the pressure indicator, i.e. the pointer, in space.

Said at least one reference is a sign, a marking or a shape situated on or in the vicinity of the dial acting as a reference point enabling determination of a position of the pressure indicator relative to this reference and deduction therefrom of a gas pressure.

Said at least one reference is situated on the dial or in the vicinity of the dial, for example at least one dot, disk, square, triangle, polygon, a three-dimensional shape, a line, etc.

It comprises a plurality of references, for example a plurality of squares.

It comprises between 1 and 5 references, preferably between 1 and 3 references.

In accordance with a first embodiment, it comprises at least one reference distinct from the geometric shapes forming the two-dimensional code, preferably a single reference, in particular a graphic element.

In accordance with a second embodiment, it comprises at least one reference forming part of the geometric shapes forming the two-dimensional code, in particular a two-dimensional code of QR code type.

The invention moreover concerns a fluid, in particular gas, distribution valve unit comprising a pressure gauge in accordance with the invention, preferably a valve unit with integrated pressure regulator.

The invention also concerns a fluid, in particular gas, distribution system comprising a gas container, such as a gas cylinder, to which is fixed a fluid distribution valve unit equipped with a pressure gauge, characterized in that the fluid distribution valve unit is a valve unit in accordance with the invention.

The valve unit is preferably protected by a protective cap.

Such a fluid distribution system and/or such a valve unit perfectly adapted to use for distribution of a pressurized fluid, in particular gas at a pressure up to 350 bar, or more.

Moreover, the invention also concerns a method for measuring the pressure displayed by a pressure gauge according to the invention, equipping a fluid distribution valve unit arranged on a gas container, which includes the steps of:

a) at least one image of the dial of the pressure gauge is acquired, said at least one image comprising the two-dimensional code, at least one reference acting as a reference position and the mobile pressure indicator,

b) said at least one image is processed to decode therein said at least one given information item encoded by the two-dimensional code,

c) said at least one image is processed to detect the position and the orientation of the two-dimensional code defining said at least one given information item,

d) the raw image obtained in the step a) is compared to the information as to the position and the orientation of the two-dimensional code obtained in the step c) to deduce therefrom an area of interest of the pressure indicator on the dial in said at least one image obtained in the step c),

e) the information obtained in the steps c) and d) is processed to deduce therefrom the position of the pressure indicator relative to the two-dimensional code or to said at least one reference (13) acting as a reference position, and

f) a pressure value measured by the pressure gauge is deduced from the position of the pressure indicator. The method of the invention may comprise one or more of the following technical features, as appropriate:

The image acquisition of the step a) is carried out using a digital reading device, in particular a device including a video camera.

In the step a), a raw image is acquired.

The two-dimensional code is a QR code.

The two-dimensional code includes at least one reference acting as a reference position.

The two-dimensional code includes a plurality of references (some or all) acting as reference position.

The two-dimensional code includes three references, notably graphic elements, acting as reference position, preferably having a square shape.

The steps b) to f) are executed by a microprocessor and software.

Said at least one image is analyzed with the aid of one or more shape recognition mathematical algorithms to determine the position of the dial and/or of the pressure indicator.

In the step e), the image representing the position of the pressure indicator on the dial is compared to stored images each corresponding to a given pressure value.

It further comprises a step of storing at least one given information item encoded by the two-dimensional code of the marking, the pressure value that has been determined, the date of the reading, the information for identifying the reading terminal and its geolocation.

It comprises a step of displaying the pressure value that has been determined and at least one given information item encoded by the two-dimensional code of the marking.

The digital reading device is a smartphone or a digital tablet integrating a video camera and a data display screen.

At least one given information item encoded by the two-dimensional code of the marking is stored and/or displayed in association with a pressure value determined in the step f).

It further comprises a step of displaying the pressure value that has been determined and at least one given information item encoded by the two-dimensional code of the marking.

It further comprises a step of displaying the quantity of gas remaining in the cylinder obtained by combining information present in or deduced in the two-dimensional code and the pressure value.

It further comprises a step of displaying the quantity of gas consumed from the cylinder, deduced from readings of the same pressure gauge effect at different times.

It further comprises a step of displaying the remaining capacity of the cylinder, deduced from the pressure that has been read and typical values of the flow rate of the gas contained in the cylinder (the flow rate value is entered by the user or deduced as a difference compared to a reading effected beforehand, for example).

The digital reading device is a smartphone or a digital tablet integrating a video camera and a data display screen.

At least one given information item encoded by the two-dimensional code of the marking corresponds to a gas cylinder reference, a unique identification number, a user name, a gas type, a gas composition, a link to an Internet site, a gas supplier name, a capacity of the cylinder, a use by date of the gas stored in the cylinder, a telephone number to contact in the event of a problem.

At least one given information item encoded by the two-dimensional code of the marking is stored and/or displayed in association with a pressure value determined in the step e).

### BRIEF DESCRIPTION OF THE DRAWINGS

The invention will now be better understood thanks to the following detailed description given by way of nonlimiting illustration with reference to the appended figures, in which:

FIG. 1 represents a prior art pressure gauge,

FIG. 2 represents a pressure gauge of a first embodiment of the invention,

FIG. 3 represents a pressure gauge of a second embodiment of the invention,

FIG. 4 shows diagrammatically the principal steps of the method in accordance with the invention of measuring the pressure displayed by the pressure gauge from FIG. 3,

FIG. 5 illustrates the acquisition of the image of the dial of the pressure gauge from FIG. 2 by means of a smartphone, and

FIG. 6 illustrates the display of the measured pressure and other useful information on the display screen of a smartphone.

### DESCRIPTION OF PREFERRED EMBODIMENTS

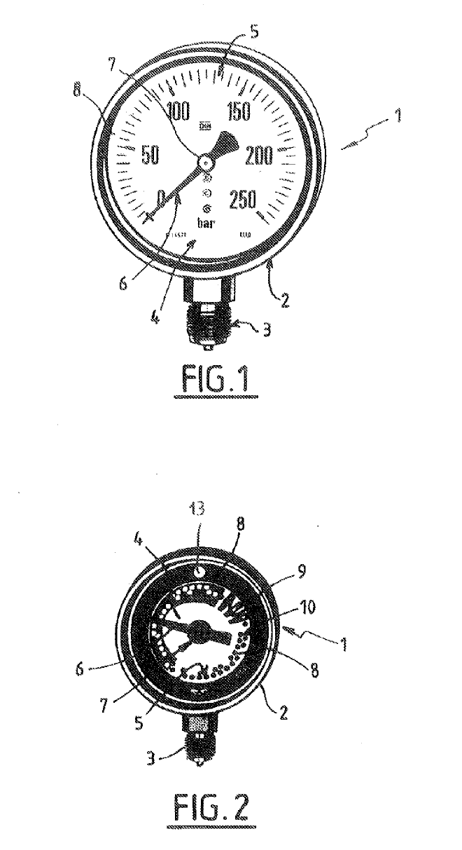

FIG. 1 represents a prior art pressure gauge 1 that can be used to measure the pressure of a pressurized fluid, in particular a gas, stored in a container, such as a gas cylinder.

The pressure gauge 1 is typically fixed, in particular screw-fixed via a threaded fixing tip 3 carried by the housing 2, to a valve unit, with or without integrated pressure regulator, itself mounted on the fluid container so as to be able to measure the pressure of the fluid leaving the container and passing through said valve unit.

A pressure gauge 1 of this kind is formed of a housing 2 containing a pressure-sensitive internal elastic mechanism (not visible) cooperating with a pressure indicator capable of rotating, namely and generally a pointer 6 capable of rotating about a rotation axis 7 usually situated at the center of a disk-shaped dial 4, i.e. one having a circular periphery, bearing graduations 5 corresponding to pressure values, namely here pressure values between 0 and 250 bar inclusive. The pressure tapping is at the level of the tip 3.

The pressure of the gas measured by the pressure gauge 1 may conventionally be read by the user on the dial 4 given that the rotary pointer 6 is positioned because of the effect of the pressure of the fluid in front of the graduation 5 corresponding to the value of the pressure of said fluid.

The dial 4 and the pointer 6 are protected by a transparent glass 8 that covers them. The glass 8 is fixed to the housing 2.

The pressure-sensitive elastic mechanism is for example a Bourdon tube or a diaphragm. This type of elastic mechanism usually equips aneroid pressure gauges that utilize the elasticity of a metal component the deformation of which by the pressurized fluid, for example the deflection of a diaphragm or the variation of curvature of a wound tube, such as a Bourdon tube, makes it possible to determine reliably the applied pressure difference and therefore the pressure of the fluid.

This type of prior art pressure gauge 1 does not allow easy stock management and has other disadvantages, notably:

The exactness of the pressure reading depends on a good understanding and interpretation by the operator of the graduations inscribed on the back of the pressure gauge.

The measured value (often expressed in bar) does not have an immediate meaning for the user, who generally wishes to know how much gas remains in the cylinder (expressed in time units, for example in hours and minutes) or the consumption of gas during a particular period. This information must be obtained by calculation from the pressure value that has been read.

It is clear that reading, interpretation and/or calculation errors can occur with this type of prior art pressure gauge 1.

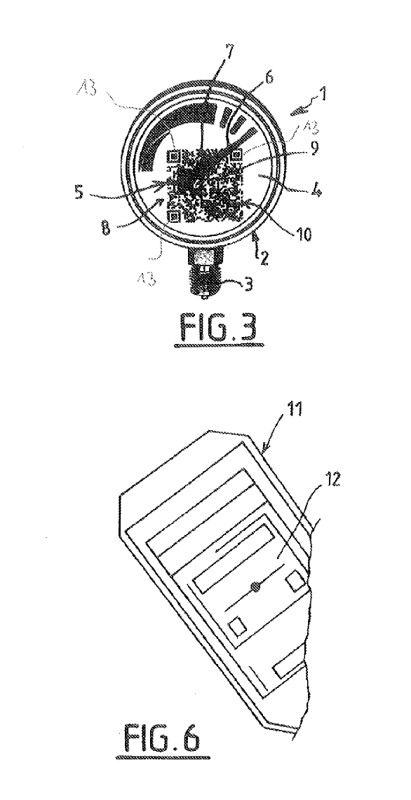

FIGS. 2 and 3 represent two embodiments of a pressure gauge 1 in accordance with the invention. The pressure gauges 1 shown diagrammatically in FIGS. 2 and 3 have the same global architecture and function in the same manner as that from FIG. 1. The same references in FIGS. 1, 2 and 3 moreover designate the same components.

Generally speaking, the pressure gauge 1 from FIGS. 2 and 3 comprises, regardless of the embodiment concerned, a dial 4 carrying a marking 5, 9 and a pressure indicator capable of rotating about the axis 7 and relative to said dial 4, namely an elongate pointer 6. The pressure indicator 6 and the dial 4 are protected by a transparent glass 8.

The pressure of the gas is measured by the internal elastic mechanism that cooperates with the pointer 6, as explained above, and this pressure measurement is then displayed by the pointer 6, which rotates because of the effect of the pressure and is positioned relative to the marking 5, 9 to indicate a pressure value corresponding to the pressure of the fluid in the container on which the valve unit carrying the pressure gauge 1 of the invention is mounted. The pressure indicator 6 is an elongate pointer of dark color, in particular black.

In accordance with the invention, the marking 5, 9 comprises a two-dimensional code 9 encoding at least one given information item. The two-dimensional code 9 comprises geometric shapes 10, namely here a multitude of small disks or squares, the organization and the number whereof encode one or more given information items.

Moreover, the dial 4 further comprises one or more references 13, also referred to as anchor elements, namely here one or more graphic elements, acting as reference position making it possible to position the pressure indicator, i.e. the pointer 6, in space.

In the FIG. 2 embodiment, the geometric shapes 10 of the two-dimensional code 9 are black and white disks distributed at the periphery of the dial 4. Note also the presence of a single reference 13, here situated at the top of the dial 4, acting as a reference position for positioning the pressure indicator 6, i.e. the rotary pointer, on the dial and thus for determining an angular position of the pressure indicator 6 relative to this reference 13 to deduce therefrom a gas pressure and possibly thereafter a remaining quantity, as described in detail hereinafter.

This reference 13 is or comprises a geometric shape, for example a dot, a line, a square etc. Here it is a disk-shaped dot. As can be seen, in this embodiment, the reference 13 is different from the geometric shapes 10 forming the two-dimensional code 9, i.e. it is not part of the geometric shapes 10 forming the two-dimensional code 9. The presence of a reference 13 of this kind is particularly important to be able to automate the reading of a pressure value displayed on the dial 4.

In the FIG. 3 embodiment, the geometric shapes 10 forming the two-dimensional code 9 are small black squares that are distributed over a back of square shape and of contrasting color to the colors of the back of the dial, typically a white or black square. Typically, the two-dimensional code 9 is of QR code type here.

As can be seen, in this FIG. 3 embodiment, the dial 4 bears a plurality of references 13, namely graphic elements, incorporated in the geometric shapes 10 forming the two-dimensional code 9, i.e. it is part of the geometric shapes 10 forming the two-dimensional code 9.

To be more precise, the geometric shapes 10 define or trace out a square general shape forming the QR code type two-dimensional code 9 and three graphic references 13 are approximately positioned in three of the corners of the square general shape forming the two-dimensional code 9.

In order to identify the position of the pointer 6 on the dial 4 automatically, one or more of these references 13 may be used, each of which may act as a reference position for positioning the pointer 6 in space.

The references 13 shown in FIG. 3 are square in shape.

Generally speaking, and regardless of the embodiment concerned, the given information item or items encoded by the two-dimensional code 9 of the marking 5, 9 correspond(s) for example to a gas cylinder reference, a user name, a gas type, a gas composition, a link to an Internet site, a gas supplier name, a use by date of the gas stored in the cylinder, a telephone number to be contacted in the event of a problem or any other useful information.

The two-dimensional code 9 may be printed, stuck, screenprinted or deposited by any other technique on the dial 4.

Disposing a two-dimensional code 9 of this type on the dial 4 of the pressure gauge 1 is particularly advantageous because this makes it possible to facilitate the management of stocks of gas cylinders and to have available more information concerning the various cylinders than only the pressure read off by the user.

Moreover, a two-dimensional code 9 of this kind makes it possible to automate the reading of the pressures displayed on the dial 4 and to be able to associate them, without risk of error, with one or other useful information items, such as those mentioned above, and preferably to store them in association with one another.

Thus in accordance with the invention it is possible to read automatically the pressure value given by the pointer 6 and information items encoded by the two-dimensional code 9, for example gas cylinder reference, user name, gas type or gas composition, etc., and to associate them with one another and thereafter to display them and/or to memorize them in association with one another.

Furthermore, this makes it possible to exploit the communication functions of an intelligent telephone or a touch-sensitive tablet in order to transmit the information item read and recovered locally to remote servers. Subsequent computer processing will make it possible to process this data and to make it available in a form that is advantageous for the user, such as a simplified view of a stock of cylinders, for example.

In other words, thanks to the reference 13, it is now possible to measure the pressure displayed by the pressure gauge 1 from FIG. 2 or 3 in an automated manner and in association with one or other information items by the method described hereinafter.

By way of illustrative example and to facilitate understanding, there is referred to hereinafter the pressure gauge 1 with dial 4 bearing a QR code type two-dimensional code 9 as shown in FIG. 3.

As already stated, in this embodiment, the QR code type two-dimensional code 9 comprises three references 13 having a square shape, all or only some of which may be used as reference positions for positioning the pointer 6 on the dial 4.

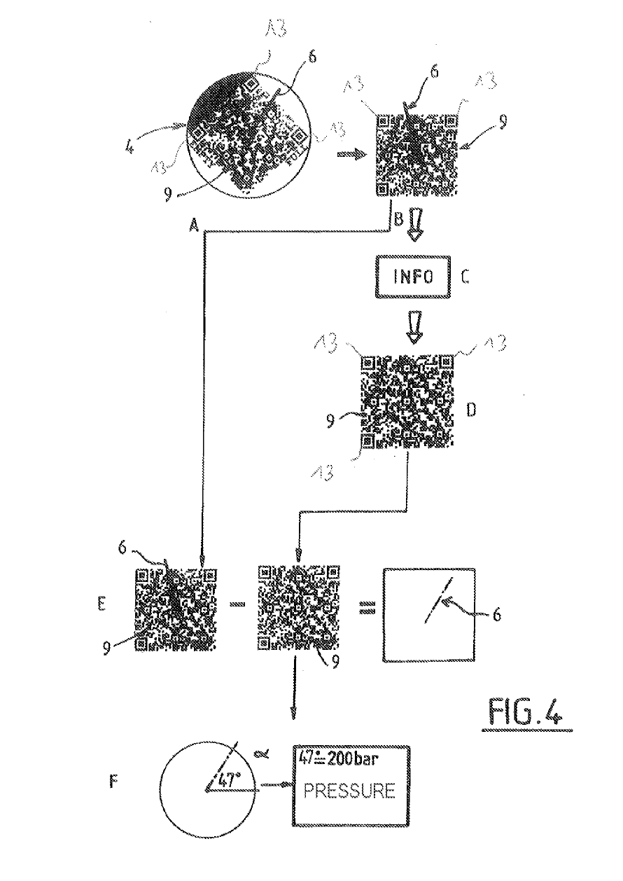

FIG. 4 illustrates the steps of the method in accordance with the invention.

First, one or more images, referred to as raw images, of the dial 4 of the pressure gauge 1 from FIG. 3 are acquired (steps A and B), which image or images including the two-dimensional code 9, including the three references 13, and the mobile pressure indicator, i.e. the pointer 6 positioned facing said two-dimensional code 9.

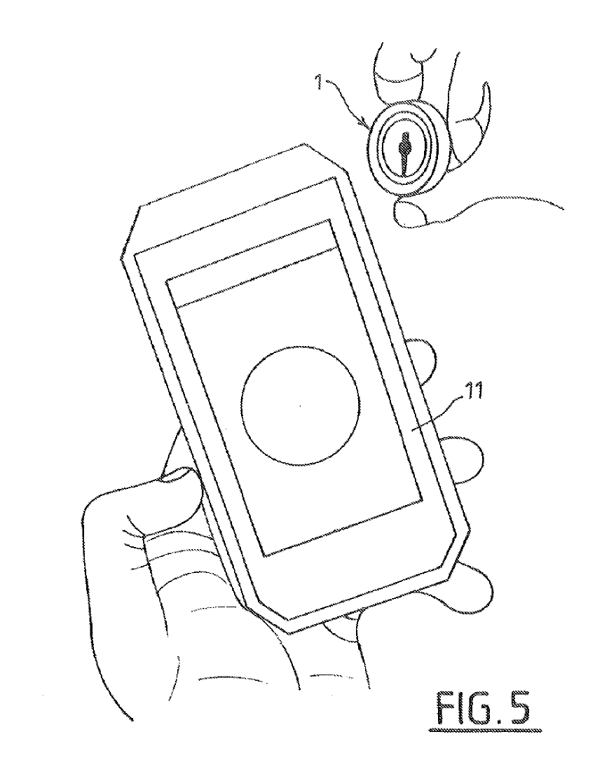

One or more images may be acquired by means of a video camera, for example a video camera arranged on an appropriate digital reading device 11, such as an intelligent telephone (smartphone) or the like, as explained hereinafter with reference to FIGS. 5 and 6.

This image or these images is or are processed (step C) to decode therein the information item (or items) INFO encoded by the two-dimensional code 9.

The position of the pointer 6, which could be superimposed on some information of the two-dimensional code 9, does not impede the decoding of the information item INFO thanks to the use of image recognition and data reconstruction techniques that are appropriate to the technology for encoding the two-dimensional code 9 and are known to any person skilled in the art.

Moreover, detecting the two-dimensional code 9 also makes possible a precise knowledge of the position and the orientation of the two-dimensional code 9 in the image or images and makes it easy to select within the image the area of interest including the pointer 6 and to reconstitute its position in space, i.e. its angular position on the dial 4.

Knowing precisely the position and the orientation of the two-dimensional code 9 and/or the pointer 6 is made possible and easy thanks to the presence of the reference or references 13 on the dial 4, and thus also in the image or images.

Thereafter one or more image recognition and shape recognition algorithms, which are well known to the person skilled in the art, are employed to detect in the area of interest the position and the orientation of the pointer 6 on the dial 4 thanks to the frame of reference constituted by one or more graphic references 13.

It is possible, for example, although this list is not exhaustive:

to employ an algorithm to recognize contours of the area of interest, followed by a Houg transform, thus detecting the predominant direction of the recognized contours; or

to employ a contour recognition algorithm followed by detection of the maximum value from a transformation into polar coordinates centered on the area of interest; or

to subtract a reference image from the image to eliminate therefrom the geometrical composition corresponding to the information item INFO encoded and thus to obtain only the image of the position of the pointer 6 on the dial 4, which is thereafter compared with a reference position, for example a reference angular position.

Finally, the position and the orientation of the pointer 6 on the dial 4 are compared with the position and the orientation of the two-dimensional code 9, therefore with the graphic reference or references 13 included in the QR code, to deduce therefrom a pressure value measured by the pressure gauge 1.

For example, the processing of the image of the position of the pointer 6 may be compared to a reference angular position to determine an angle α, for example of 47° here, which angle a is itself used to deduce a pressure value, for example 200 bar, from a table of correspondences or the like established beforehand establishing the correspondence between angle values α and corresponding pressure values.

A table of correspondences of this kind may easily be established via simple empirical tests. It is then stored and can be retrieved to proceed to said comparison.

As shown in FIG. 5, the raw image of the dial 4 of the pressure gauge 1 is preferably acquired by means of a digital reading device 11, in particular a device including a video camera, such as an intelligent telephone or a digital tablet, equipped with a video camera and employing an application or module for reading a two-dimensional, notably QR, code, for example the Manatee Works Barcode Scanner SDK code reading module running in an Android™, IoS or Windows Mobile environment.

For example, the steps of the method described above have been executed on an intelligent telephone functioning in an Android™ environment and using software employing an image processing library such as OpenCV™

The pressure value determined in this way may then be stored, preferably in association with the information item or items encoded by the two-dimensional code 9 and decoded as explained above.

Of course, some or all of the information, images or other data may be stored and/or displayed on a data display screen, such as the screen 12 of a digital reading device 11, such as an intelligent telephone or a digital tablet, as shown in FIG. 6.

The present invention is particularly useful for the effective management of a stock of gas containers such as gas cylinders.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1-17. (canceled)

18. A pressure gauge comprising a dial comprising a marking and a pressure indicator configured to rotate with respect to the dial, the pressure indicator capable of changing orientation and/or position relative to the marking as it rotates, wherein:
the marking comprises a two-dimensional code that encodes at least one given information item, and
at least one graphic element acting as a reference position so that the pressure indicator may be positioned in space.

19. The pressure gauge of claim 19, wherein the two-dimensional code comprises geometric shapes.

20. The pressure gauge of claim 19, wherein the two-dimensional code comprises geometric shapes chosen from disks and polygons.

21. The pressure gauge of claim 19, wherein the geometric shapes are disks distributed over at least a part of the periphery of the dial.

22. The pressure gauge of claim 19, wherein the pressure indicator is a pointer.

23. The pressure gauge of claim 18, wherein the at least one graphic element comprises a geometric shape.

24. A valve unit for distributing fluid, comprising a pressure gauge as claimed in claim 18.

25. A fluid distribution system comprising a gas container to which is fixed a fluid distribution valve unit equipped with a pressure gauge, wherein the fluid distribution valve unit is a valve unit as claimed in claim 24.

26. Use of a fluid distribution system as claimed in claim 25 to distribute a pressurized fluid.

27. A method for measuring the pressure displayed by a pressure gauge as claimed in claim 18, equipping a fluid distribution valve unit arranged on a gas container, comprising the steps of:
a) acquiring at least one image of the dial of the pressure gauge, the at least one image comprising the two-dimensional code, at least one graphic element acting as a reference position and the mobile pressure indicator,
b) processing the at least one image to decode therein the at least one given information item encoded by the two-dimensional code,
c) processing the at least one image to detect the position and the orientation of the two-dimensional code defining the at least one given information item,
d) comparing the raw image obtained in the step a) to the information as to the position and the orientation of the two-dimensional code obtained in the step c) to deduce therefrom an area of interest of the pressure indicator on the dial in the at least one image obtained in the step c),
e) processing the information obtained in the steps c) and d) to deduce therefrom the position of the pressure indicator relative to the two-dimensional code or to the at least one graphic element acting as a reference position, and
f) measuring a pressure value the pressure gauge, the pressure value being deduced from the position of the pressure indicator.

28. The method of claim 27, wherein the raw image is acquired in the step a) by means of a digital reading device.

29. The method of claim 27, wherein the steps b) to f) are executed by a microprocessor and software.

30. The method of claim 27, wherein in the step e) the image representing the position of the pressure indicator on the dial is compared to stored images each corresponding to a given pressure value.

31. The method of claim 27, further comprising a step of displaying the pressure value that has been determined and at least one given information item encoded by the two-dimensional code of the marking.

32. The method of claim 27, wherein the digital reading device is a smartphone or a digital tablet incorporating a video camera and a data display screen.

33. The method of claim 27, wherein at least one given information item encoded by the two-dimensional code of the marking corresponds to a gas cylinder reference, a user name, a gas type, a gas composition, a link to an Internet site, a unique identification number, a gas supplier name, a capacity of the cylinder, a use by date of the gas stored in the cylinder and/or a telephone number.

34. The method of claim 27, wherein at least one given information item encoded by the two-dimensional code of the marking is stored and/or displayed in combination with a pressure value determined in the step f).
